(19) United States
(12) Patent Application Publication
(10) Pub. No.: US 2017/0328416 A1
(43) Pub. Date: Nov. 16, 2017

(54) Universal Joint

(71) Applicant: Ulterra Drilling Technologies, L.P., Fort Worth, TX (US)

(72) Inventors: Jason Maw, Beaumont (CA); Beau J. St. Pierre, Hudson Oaks, TX (US)

(21) Appl. No.: 15/593,286

(22) Filed: May 11, 2017

Related U.S. Application Data
(60) Provisional application No. 62/334,943, filed on May 11, 2016.

(51) Int. Cl. F16D 3/52; E21B 7/04; E21B 17/05; F16D 3/72

(52) U.S. Cl. CPC F16D 3/52; F16D 3/72; E21B 7/04; E21B 17/05

(57) ABSTRACT

A universal joint assembled in a drill string transfers torque between two components where rotation of the components may not be completely aligned. The universal joint includes upper and lower members with radial teeth connected by a serpentine retainer. As the joint rotates the members can pivot within the confines of the serpentine retainer to accommodate misalignment of the components. Axial force can be transferred through a bearing member between the members.

### RELATED APPLICATION

This application claims the benefit of U.S. Provisional Application No. 62/334,943, filed May 11, 2016, entitled, “Universal Joint,” which is incorporated herein in its entirety by reference for all purposes.

### FIELD OF THE INVENTION

This invention relates to universal joints used in downhole drill strings.

### BACKGROUND

Universal joints are used in mechanical applications to transmit torque between components where there can be misalignment of rotating parts. In a drilling operation, a drill bit is mounted to the end of a drill string. The drill string is rotated from the top of the string or by a motor at the bottom of the string, or both, to rotate the drill bit and advance the borehole. Universal joints can be included in the drill string to accommodate rotational eccentricity. The eccentric rotation is converted into axial rotation in order for the drill bit to advance the borehole efficiently. Eccentricity can be initiated by a motor in the drive assembly that rotates the drill bit or by steering of the bit to change direction of the borehole.

FIG. 1 is a schematic representation of a drilling operation 2. In conventional drilling operations a drill bit 8 is mounted on the end of a drill string 6 comprising drill pipe and drill collars. The pipe sections of the drill string are threaded together at their ends to create a pipe of sufficient length to reach the bottom of the wellbore 4. The drill string may be several miles long and the bit is rotated in the bore either by a motor proximate to the bit or by rotating the drill string or both simultaneously. A pump circulates drilling fluid through the drill pipe and out of the drill bit flushing rock cuttings from the bit and transporting them back up the wellbore. Additional tools 10′ can be included in the drill string such as motors and vibrators.

The components of the drill string including the universal joint are subjected to extreme torque forces, elevated operating temperatures and abrasive drilling fluids, all of which can have an adverse effect on the operational life of drill string components. Constant relative movement of the components of a universal joint during operations, together with abrasive drilling mud, causes abrasion and erosion of mating components. Attempts have been made to effectively seal the universal joint assemblies so as to prolong their operational life. Due to the constant relative movement of the components and aggressive downhole environment, they do not readily lend themselves to conventional sealing arrangements. Operational failure of the joint or its components requires removal of the drill string from the borehole and downtime for the operation which increases operational expenses substantially.

A universal joint that is less vulnerable to abrasion and erosion with an extended service life and few moving parts would be advantageous.

### SUMMARY OF THE INVENTION

The present invention provides a universal joint assembly to be used as part of a downhole drill string.

In one aspect of the invention, an upper and lower members each includes engaging

elements around its perimeter that are engaged by portions of a flexible retainer overlying both members to enable eccentric torque to be converted to generally axial torque. In one embodiment, the engaging elements are slots or teeth that engage ribs of the retainer.

In one other aspect of the invention, an upper member and a lower member are joined by a serpentine retainer that engages circumferential teeth on both members to maintain rotational relation of the connected members. With the assembly under torque, the lower member rotates with the upper member to transmit torque. The retainer provides limited movement between the members to accommodate axial, angular and/or lateral misalignment between shafts. The serpentine retainer can also flex to allow limited rotation of the upper member in relation to the lower member. The serpentine retainer or connector element joining the toothed members provides a compact assembly allowing the components of the drill string to be positioned close together shortening the drill string. The joint has limited moving parts, few components and is inexpensive to manufacture.

In another aspect of the invention, a downhole tool includes first and second bodies and a retainer engaging radially extending teeth on each body.

In another aspect of the present invention, a universal joint assembly for downhole applications includes two circumferentially toothed members that each accept adjacent components of the drill string. The members are connected by a flexible retainer engaging corresponding teeth of the members to transmit torque between drill string components. In one embodiment, the retainer has a serpentine configuration.

In another aspect of the invention, an assembly to transfer torque in a downhole drill string includes first and second bodies, correspondingly slotted along their rims. The first and second bodies are joined by a retainer passing through the aligned slots of the bodies.

In another aspect of the invention a downhole tool includes members spaced by a bearing element and retained by a retainer engaging teeth around edges of each member.

In another aspect of the invention the universal joint is used in conjunction with a positive displacement motor and/or a radial impulse tool. In another aspect of the invention, connectors of each member attach to adjacent tools of the drill string. In another aspect of the invention, a bearing element (e.g., in the form of a ball bearing) is retained between upper and lower members to transfer axial loads through the joint. In another aspect of the invention the serpentine member comprises a carbon fiber or Kevlar®.

### BRIEF DESCRIPTION OF THE DRAWINGS

FIG. 1 is a schematic diagram of a drilling operation.

FIG. 2 is an exploded view of a universal joint in accordance with the invention.

FIG. 3 is a perspective view of the universal joint.

FIG. 3A is a side view of a portion of the universal joint of FIG. 3 in one operational position.

FIG. 3B is a side view of a portion of the universal joint of FIG. 3 in another operational position.

FIG. 4 is a partial cross section perspective view of the universal joint.

FIG. 5 is a schematic of an example upper and lower element orientation.

FIG. 6 is a cross section view of an alternative embodiment universal joint.

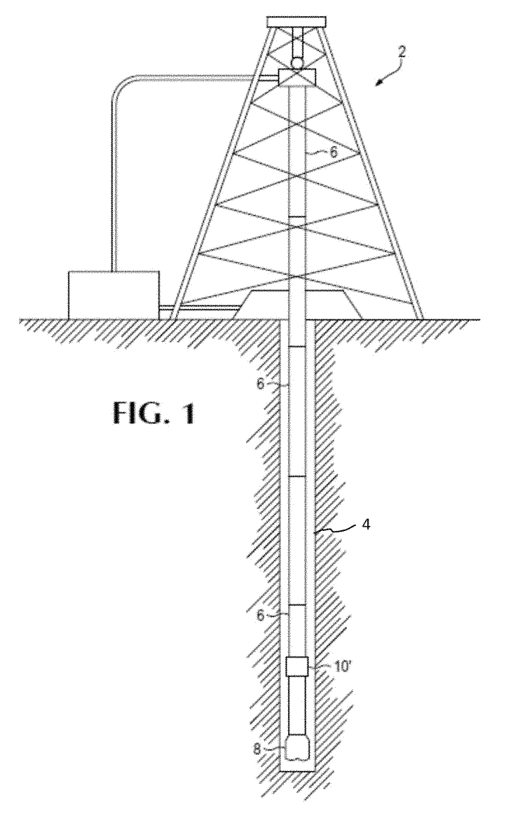

### DETAILED DESCRIPTION OF THE PREFERRED EMBODIMENTS

A drill string in its basic form consists of sections of threaded pipe and tools assembled end to end with a drill bit at a distal end for advancing a borehole. The drill string can be miles long and rotated at a proximal end of the pipe by a drilling rig to turn the drill bit and advance the borehole. Many different components can be assembled to the drill string to perform a range of functions such as reaming out obstructions from the borehole, widening the borehole or vibrating the drill string to mitigate friction between the string and the borehole.

Positive displacement or mud motors can be installed at the distal end of the drill string to drive the drill bit instead of, or in addition to, driving the drill string from the above ground drill rig. Fluid is pumped down the drill string during operation under pressure to flush material out of the borehole. A mud motor uses the pressure of the fluid to drive a rotor in a stator housing. The output of the motor is eccentric, with the output shaft rotating about a circle as well as rotating about its axis. In order to limit the stress on the drill string and bit, one or more universal joints are installed as part of the drill string. The universal joint transmits the torque to the drill bit and converts the eccentric rotational component to axial rotation.

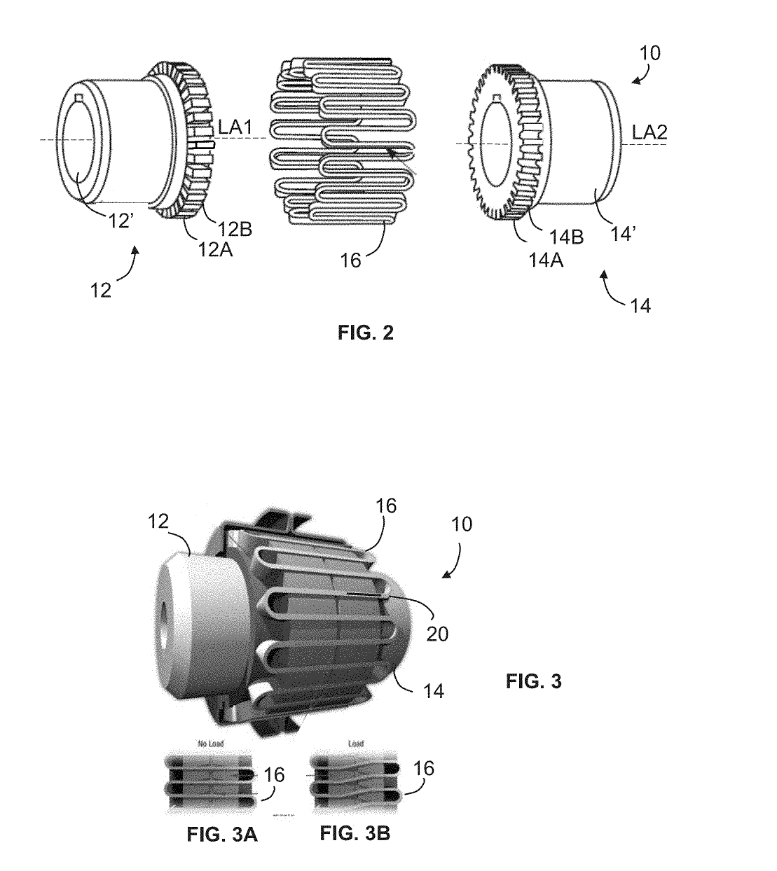

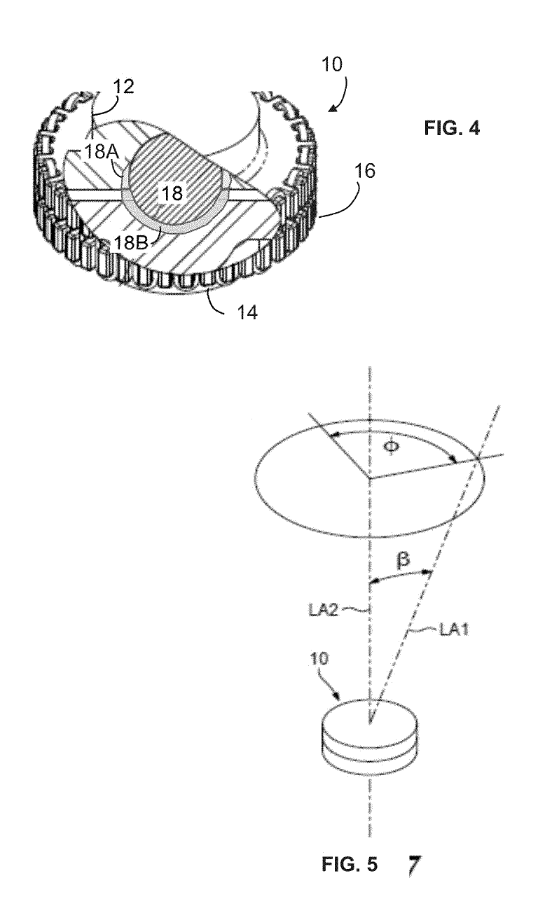

A universal joint 10 is shown in FIGS. 2-6. The universal joint can transmit significant torque and flexes to compensate for misalignment of transmitting and receiving elements. Although the universal joint is discussed in relation to a mud motor and a bit, the joint can be used in any downhole rotating application.

The disclosed universal joint assembly 10 includes a top member 12 and a bottom member 14 with respective longitudinal axes LA1 and LA2. Top member 12 preferably has a connector 12′ at one end for joining to drill string components and radially extending teeth 12A spaced by slots 12B around a circumferential edge. Bottom member 14 has a corresponding construction with a connector 14′ and teeth 14A spaced by slots 14B around a circumferential edge. Top and bottom members generally have planar faces opposite the connectors and preferably have identical configurations. Other constructions with non-planar and/or non-identical configurations are possible.

In one embodiment, upper and lower members are assembled with the planar faces opposite each other. The corresponding teeth of the members are generally aligned. The members are connected by a serpentine retainer or ring 16 that passes through the aligned slots 12B. 14B sequentially around the circumference of the joined members. The serpentine retainer comprises bars or ribs with separating loops on alternating sides. In this embodiment, the ribs are straight parallel sections with arcuate loops but other configurations are possible. The retainer can be elastic to stretch over the circumference of the members so the ribs can individually seat in the slots 12B and 14B. The retainer in the slots returns to an unexpanded or relaxed state. In other embodiments, the retainer can have a non-serpentine configuration.

For example, the retainer ribs could be coupled with loops on each end or only on a one end of the multiple ribs. While the retainer is shown with a consistent construction it could alternatively have different constructions at different portions. Although a series of teeth with intervening slots is shown, other engaging elements to movably connect with the ribs of the retainer are possible. The teeth also could have lateral ends to resist any disconnection of the retainer from the teeth during use. Also, the ribs could pass through bores that are closed to prevent disconnection. Typically, no part of either of the upper or lower members extends across the plane to engage the opposite member. Other configurations with portions of a member extending past the planar surfaces are possible.

A bearing element 18 can be retained between the upper and lower members to carry axial loads and/or space the members. Spacing the members allows them to pivot on the bearing and accommodate for misalignment of the components attached to the members. The members can pivot in relation to each other within a range without contact at their circumference. Beyond that range the members can pivot and make contact at their circumference.

The upper member generally pivots in relation to the lower member about the axis of the lower member and about a point near the center of the bearing element. Rotation can be measured as the angular deflection “β” of the longitudinal axis LA1 of the upper member in relation to the longitudinal axis LA2 of the lower member. The upper member can also move with axis LA1 making an angular deflection “θ” about the axis LA2. In a typical application, the angle θ is constant and the angle θ sweeps zero to 360 degrees though variations are possible. The maximum angular deflection of the upper member in relation to the lower member is a function of the spacing of the members and the dimensions of the retainer.

Properties of the joint materials should exceed the loads expected to be applied to universal joint during operation such as flexural force, torque and axial force. The upper and lower members 12, 14 can be a material such as polymer, metal, a hybrid construction of metallic elements embedded in an elastomer or other material. The serpentine retainer 16 can be a metal, carbon fiber, Kevlar®, matrix or other material.

The serpentine retainer 16 at each aligned slot transmits the load from the upper member to the lower member. As shown in FIG. 3B each straight portion of the retainer extending between and connecting the teeth can flex or deflect under the applied load. The teeth along the circumferential edge forming the slots in some embodiments can also deflect to absorb a portion of the applied load. Where the shafts attached to the upper and lower members are not completely aligned, the spacing between corresponding teeth of the opposing members can vary around the circumference of the members as the joint compensates for the misalignment. The length of straight portions separating the sequential loops of the serpentine retainer can define the limit of separation between the corresponding teeth when the teeth contact the opposite loops.

The teeth as shown are rectangular lugs. The teeth can take on other shapes such as lenticular or elliptical lugs with various end chamfers and fillets to accommodate spring displacement under torque. Alternatively, the teeth can be cylindrical.

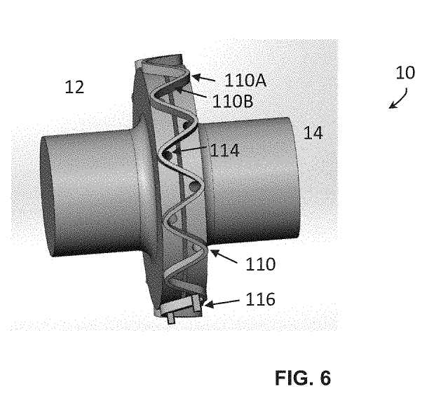

FIG. 6 is an alternative embodiment of a universal joint. The upper and lower members 12, 14 each have holes 114 around the circumference of the member. A retainer 110 formed as a ring is positioned around the mated upper and lower members. The retainer has loops 110A separated by ribs 110B. With the retainer in position adjacent the members, pins 116 are installed in the holes at the loops. Two pins are shown installed. The pins act in a similar manner to the teeth of previous embodiments and rest in the loops of the retainer. The retainer and pins maintain a general positional relationship of the upper and lower members.

With the retainer sized to fit over the circumference of the members on being assembled, retainer 110 can be more rigid. The ribs between loops are shown as extending at an angle to the longitudinal axis. This allows the members limited rotation in relation to each other with less deflection of the retainer. The axial distance between the loops can determine the maximum separation of the members at any point around the circumference. The radius of diameter of the loops of the retainer and the angle of the ribs between loops as well as the rigidity of the retainer can be modified to provide more or less resistance to rotation of the members. Alternatively, some pins could be installed in openings while other pins are fixed in place.

Axial force applied to the universal joint can be transmitted through the bearing seats 18A, 18B and the bearing element 18. With a ball bearing as the bearing element, the seats and the ball bearing concentrate the axial force at the contact faces. The bearing seats can be concave and curved to better retain the ball bearing and to increase the contact surface area between the seats and the ball.

The bearing seats can be a different material than the top and bottom members.

Both the seat and the ball bearing are preferably made of very hard materials to keep from deforming at the contact points and to limit erosion and spalling from the high normal forces. As examples, material used for seats and bearing elements can include chrome steel, stainless steel and ceramic such as silicon nitride. The seats may also be a hybrid material with a body of softer metal and a surface that contacts the ball bearing of the much harder material.

The ball bearing and bearing surfaces are used as an example for illustration. Other elements such as an axial member can be used to transmit axial force instead of, or in combination with, bearing element 18 and still fall within the scope of this disclosure. The bearing element can be a rod.

In downhole applications, the forces experienced by the bearing member are not always predictable. Where the universal joint experiences more extreme flexure or axial force or more wear than expected, the service life can be shorter than predicted. Early failure of the component can require unplanned extraction of the drill string from the hole incurring substantial expense. The universal joint 10 can include a service life indicator 20 that displays a gauge of remaining service life for the component. The indicator can allow the operator to replace the universal joint before a downhole failure.

In one embodiment the service life indicator 20 is a fatigue indicator. The fatigue indicator can be a strand or coating on the retainer as shown in FIG. 3 that flexes with the retainer in service. Alternatively, the fatigue indicator can be associated with the upper or lower element. The fatigue indicator can be a material selected to have a more limited service life than the bearing member, bearing element or retainer.

For example the fatigue indicator can be selected to have a fatigue life 80% of the life of the serpentine retainer or the element or the assembly as a whole. Reduced service life of the fatigue indicator may be a factor of accelerated work hardening of the material or a harder material compared to the balance of the components of the universal joint. At 80% of the service life the wear indicator can develop visible failure mechanisms such as cracking or other visible indicia that can be detected by the operator. The universal joint can be removed from service in response to visual inspection of the fatigue indicator before the joint fails.

Components of a drill string are in contact with suspended particles of the drilling fluid that are abrasive and can erode the components. Components that have sliding contact with high normal forces are especially subject to erosion as the suspended particles between the sliding components accelerate erosion of the surfaces. Particles between the retainer and teeth can abrade their contact surfaces. In one embodiment the service life indicator 20 is a wear or erosion indicator. The wear indicator can include an insert or coating included in the member as part of the member tooth. Erosion of the insert to a critical thickness can be detected by the operator. Alternatively, the erosion indicator can be a coating of a material that provides a visual indication of erosion.

Alternatively, the service life indicator can indicate an overstress event. Where the universal joint experiences a level of torque near or above the service limit, the indicator can provide a visual indication of the event.

While examples of service life indicators and overstress indicators have been presented, these indicators can take on other configurations and operate in different ways than those shown and still fall within the scope of this disclosure. These embodiments are presented for the purpose of illustration.

The universal joint in operation is typically an assembly inside the drill string so that there is an outer casing of the drill string with tools inside such as the mud motor and universal joint. In some embodiments, the assembly may be extracted from the inside of the drill string and brought to the surface as a separate unit. When tension is applied to the universal joint at the upper member, the serpentine element maintains a connection between the upper and lower members without additional retention features as required on previous universal joints.

The universal joint disclosed above is inexpensive to manufacture, compact and durable with limited erosion and wear susceptibility. The joint can include service life indicators that allow the operator to replace the unit before operational failure.

It should be appreciated that although selected embodiments of the representative universal joints are disclosed herein, numerous variations of these embodiments may be envisioned by one of ordinary skill that do not deviate from the scope of the present disclosure. The disclosure set forth herein encompasses multiple distinct inventions with independent utility. The various features of the invention described above are preferably included in each universal joint. Nevertheless, the features can be used individually in a joint to obtain some benefits of the invention. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. While components are referred to as upper and lower, this is for the purpose of illustration. Orientations can be reversed to perform similar functions and still fall within the scope of the disclosure.

What is claimed is:

1. A universal joint assembly to be used as part of a downhole drill string, comprising:
an upper member and a lower member, each with a longitudinal axis of rotation;
a first plurality of engaging elements disposed around a perimeter of the upper member;
a second plurality of engaging elements around a perimeter of the lower member; and
a flexible retainer coupled with the first and second plurality of engaging elements for transmitting torque between the upper and lower members.

2. The universal joint of claim 1, wherein each of the first and the second plurality of engaging elements are each comprised of teeth disposed around the perimeters of the member, separated by slots, for engaging the retainer.

3. The universal joint of claim 1, wherein the first and the second plurality of engaging elements are comprised of pins.

4. The universal joint of claim 1, wherein the retainer comprises a serpentine retainer that allows for limited, relative movement between the upper and lower members to accommodate axial, angular and lateral misalignment the respective longitudinal axes of rotation of the upper and lower members.

5. The universal joint of claim 4, wherein the serpentine retainer allows for limited rotation of the upper member in relation to the lower member.

6. The universal joint of claim 4, wherein the serpentine retainer is elastic.

7. The universal joint of claim 1 wherein each of the engaging elements in the first and second plurality of engagements elements extend in a radial direction, relative to the longitudinal axis of rotation of the upper or lower member on which they are disposed.

8. The universal joint of claim 1, wherein the upper and lower members are spaced apart by a bearing element retained between upper and lower members to transfer axial loads through the joint.

9. The universal joint of claim 8, wherein the bearing element comprises a ball bearing.

10. The universal joint of claim 1, wherein the flexible retainer is comprised of one or more of metal, carbon fiber, Kevlar®, and matrix.

11. The universal joint of claim 1 wherein the upper member has a first connector for joining to a first drill string component and the lower member has a second connector for joining to a second drill string component.

12. The universal joint of claim 11, wherein one of the upper member and the lower member is coupled with a rotary output of a positive displacement motor or a radial impulse tool.

13. The universal joint of claim 12, wherein the other of the upper member and the lower member is coupled with a drill bit.

14. The universal joint of claim 1 wherein the upper and lower members each have a surface facing the other that is planar.

15. A universal joint assembly for downhole applications comprising:
two members for coupling to adjacent components of a downhole drill string, each of the two members having disposed around its circumference teeth; and
at least one flexible retainer for coupling the two members by engaging corresponding teeth to transmit torque.

16. The universal joint of claim 15, wherein at least one of the teeth comprises a rectangular lug.

17. The universal joint of claim 15, wherein at least one of the teeth has one of a lenticular, elliptical and cylindrical shape.

18. The universal joint of claim 15, wherein at least one of the teeth has formed thereon an end chamfer for accommodating displacement of the retainer when under torque.

19. The universal joint of claim 15 wherein the at least one retainer has a serpentine configuration disposed around the entire circumference of the two circumferentially toothed members.

20. The universal joint of claim 15, wherein the least one retainer is comprised of at least two parallel ribs joined.

21. An assembly to transfer torque in a downhole drill string comprising:
first and second bodies, each having a connector for joining body to an adjacent component of a downhole drill string and each having a longitudinal axis of rotation; the first body having slots formed around an outer circumference the body aligned with the slots formed around the circumference of the second body; and
a retainer passing through aligned slots in the first and second bodies.

22. The assembly to transfer torque in a downhole drill string of claim 21, wherein the upper and lower members are spaced apart by a bearing element.

23. The assembly to transfer torque in a downhole drill string of claim 22, wherein the bearing element is retained between upper and lower members to transfer axial loads through the joint.

24. The assembly to transfer torque in a downhole drill string of claim 22 wherein the bearing element comprises a ball bearing.

25. The assembly to transfer torque in a downhole drill string of claim 21 wherein one of the upper member and the lower member is coupled with a rotary output of a positive displacement motor or a radial impulse tool.

26. The assembly to transfer torque in a downhole drill string of claim 21, wherein the retainer has a serpentine configuration.

27. The assembly to transfer torque in a downhole drill string of claim 26, wherein the serpentine retainer comprises ribs that are straight parallel sections connected by arcuate loops.
